(19) United States
(12) Patent Application Publication
(10) Pub. No.: US 2006/0133019 A1
(43) Pub. Date: Jun. 22, 2006

(54) Latch assembly for an electronic device

(76) Inventors: Fuminori Yamazaki, Tokyo (JP); Kenji Shimano, Tokyo (JP); Masakazu Okumura, Tustin, CA (US); Jim Fullalove, London (GB); Martin Riddiford, London (GB); Patrick Hunt, London (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/021,312

(22) Filed: Dec. 21, 2004

(51) Int. Cl. G06F 1/16

(52) U.S. Cl. 361/683

(57) ABSTRACT

According to one embodiment of the invention, a latch assembly comprises a plurality of latches configured to engage with a plurality of latch sockets appropriately situated at corners of an electronic device. A release mechanism is adapted to secure and subsequently release the plurality of latches from the plurality of latch sockets. The release mechanism includes a spring-biased release button, and a plurality of links rotationally coupled to the release button. The first link is adapted to prevent vertical movement of the first latch when the first link is placed in a first position caused when the cover is placed in a closed position. When the release button is depressed, the first link is placed into a second position to allow the cover to be opened.

### FIELD

Embodiments of the invention generally relate to the field of electronic devices. More specifically, embodiments of this invention relate to a latch assembly that comprises a plurality of latches adapted for engagement with complementary latch sockets.

### GENERAL BACKGROUND

Typically, portable notebook computers feature a main body and a display cover that is pivotally attached to a back edge of the main body. For prior styles of computers and other electronic devices, a latch is implemented around the mid-section of a top edge of the display cover. The latch features a hook movably coupled to a spring-biased release button.

When the display cover is closed to rest over the main body, the hook engages with a slot formed on a top surface of the main body. This securely attaches the display cover to the main body, which protects the keyboard and display screen during transport or non-use. Depression of release button causes movement of the hook that enables the hook to be disengaged from the slot when the display cover is opened.

One problem associated with the above-described single latch configuration is that the hook has relatively little resiliency against bending since it is formed from a flat metal plate. Over time, this type of latch assembly tends to experience positional misalignment between the hook and the slot, causing difficulties in closing the display cover.

Previously, a dual latch assembly has been implemented on portable laptop computers as set forth in U.S. Pat. No. 5,465,191. However, this dual latch assembly utilizes hook mechanisms and requires the use of two hands for the user to release the cover from the main body.

### BRIEF DESCRIPTION OF THE DRAWINGS

Features and advantages of embodiments of the invention will become apparent from the following detailed description in which:

FIG. 1 is a conventional latch assembly of a portable laptop computer.

FIG. 2 is a perspective view of an exemplary embodiment of an electronic device placed in an OPEN position and featuring a latch assembly.

FIG. 3 is a cut-away view of a first exemplary embodiment of a release mechanism of the latch assembly of FIG. 2 when the electronic device is placed in a CLOSED position.

FIG. 4 is a cut-away view of a second exemplary embodiment of a release mechanism of the latch assembly of FIG. 2 when the electronic device is placed in a CLOSED position.

FIG. 5 is a cross sectional view of an exemplary embodiment of a latch socket of the latch assembly of FIG. 2.

FIG. 6 is a cross sectional view of an exemplary embodiment of a latch of the latch assembly of FIG. 2.

FIG. 7 is a flowchart of operations of the latch assembly when the latches are securely placed within their corresponding latch sockets.

### DETAILED DESCRIPTION

Embodiments of the invention set forth in the following detailed description generally relate to a latch assembly that comprises a plurality of latches adapted for engagement with complementary latch sockets. A latch release mechanism featuring a single release button controls the engagement of the latches with and disengagement of the latches from their corresponding latch sockets.

In the following description, certain terminology is used to describe various features of one or more embodiments of the invention. For instance, an “electronic device” is defined as any electronic product having a cover and a main body protecting internal electronic components therein. In this detailed description, for clarity sake, the electronic device is illustrated as a notebook computer. However, it is evident that the invention may be utilized in other types of electronic devices including, but not limited or restricted to personal digital assistants (PDAs), cellular telephones, or any other type of portable computer such as hand-held computers, tablet computers and the like.

Herein, the term “rotate” as well as varying tenses thereof is generally defined as movement about an axis of rotation. The axis of rotation may be relatively fixed to the overall orientation of the electronic device. For this detailed description, when used to denote a direction of rotation, the term “horizontally rotate” (or any tense thereof) relates to rotation about a generally vertical axis of rotation while the term “vertically rotate” (or any tense thereof) relates to rotation about a generally horizontal axis of rotation.

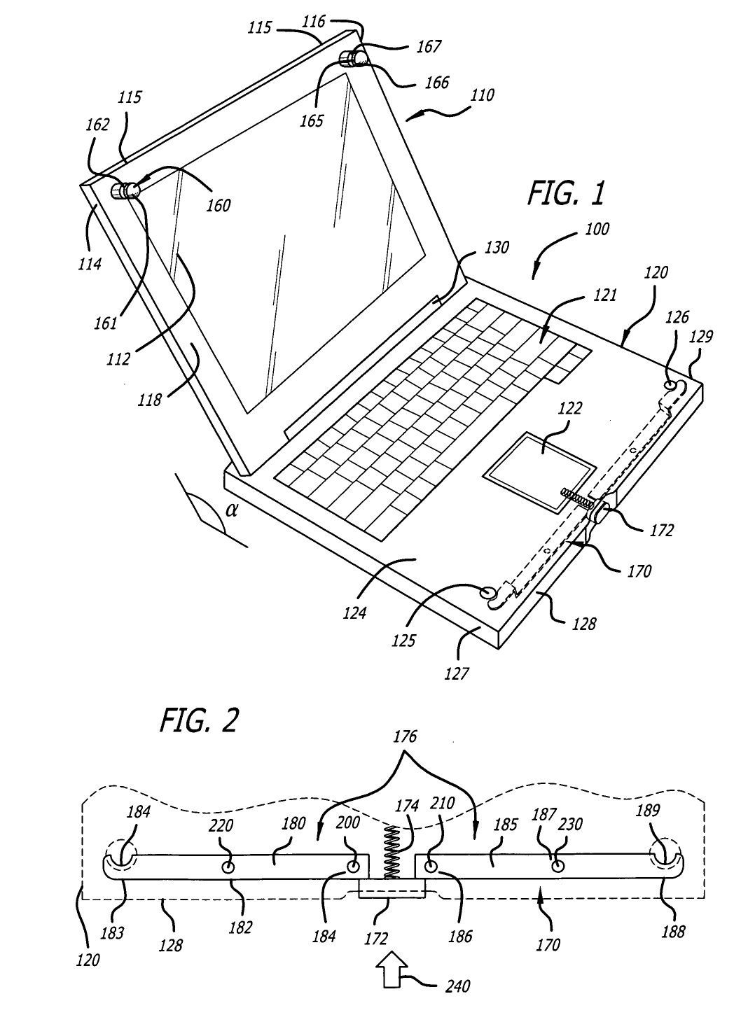

Referring to FIG. 1, a perspective view of an exemplary embodiment of an electronic device 100 placed in an OPEN position and featuring an inventive latch assembly is shown. Herein, in accordance with this embodiment of the invention, electronic device 100 comprises a cover 110 rotationally coupled to a main body 120 through a hinge mechanism 130.

As shown, hinge mechanism 130 may be adapted as one or more friction hinges such as a brake hinge for example. This allows cover 110 to be vertically rotated and maintained in any selected angle (a) of rotation, where 0°≦α<180°. It is contemplated, however, that hinge mechanism 130 need not include brake hinges when there is no need for maintaining cover 110 at an angled orientation.

Cover 110 houses a flat panel display 112 as well as all or part of the circuitry for generating a displayable image on flat panel display 112 such as a liquid crystal display (LCD) for example.

Main body 120 comprises an alphanumeric character input device 121 (e.g., keyboard) and a second input device 122, such as a touch pad, tactile device or track ball for example. These input devices 121 and 122 may be integrated as part of a top panel 124 of main body 120. Latch receiving slots 125 and 126 are made through top panel 124 and provide access to corresponding latch sockets as described below.

According to one embodiment of the invention, the latch assembly is deployed as components attached to both cover 110 and main body 120. The latch assembly comprises a plurality of latches 160 and 165, where a first latch 160 is situated at a corner proximate to intersecting edges 114 and 115 of cover 110. A second latch 165 is situated at a corner proximate to intersecting edges 115 and 116.

Each of these latches 160 and 165 includes a first end 161 and 166 and a second end (not shown) joined together by connecting elements 162 and 167, respectively. As shown, according to one embodiment, connecting elements 162 and 167 are cylindrical in shape with a cross-section diameter lesser in size than the diameters of first end 161 and 166 at the point of attachment. Likewise, cross-section diameter of connecting elements 162 and 167 is lesser in size than the diameters of the second ends at the point of attachment to connecting elements 162 and 167.

According to one embodiment of the invention, first ends 161 and 166 are configured with tapered end portions. For instance, first ends 161 and 166 are configured as convex (or hemispherical) shaped end portions. It is contemplated, however, that first ends 161 and 166 may alternatively be configured with a non-convex shape.

Latches 160 and 165 extend outwardly from a front panel 118 of cover 110 for insertion through latch receiving slots 125 and 126 when electronic device 100 is placed in a CLOSED position. As shown, latch receiving slots 125 and 126 are situated at corners proximate to intersecting sidewalls 127/128 and 128/129 of main body 120, respectively. Each of these slots 125 and 126 provide access to a corresponding latch socket that mates with one of the latches 160 and 165 as shown in FIG. 5.

Implemented within main body 120, a latch release mechanism 170 is configured to secure latches 160 and 165 to their corresponding latch sockets when electronic device 100 is placed in a CLOSED position. Electronic device 100 is placed in a CLOSED position when cover 110 is positioned to be generally flush against main body 120 and front panel 118 of cover 110 is substantially coplanar with top panel 124 of main body 120.

In response to activation of latch release mechanism 170, such as depression of release button 172 while electronic device 100 is in a CLOSED position, latch release mechanism 170 disengages from latches 160 and 165. This disengagement is concurrent and perhaps simultaneous for both latches 160 and 165 in response to an action (e.g., depression of button 170) that can be done with one hand of the user. This allows cover 110 to be vertically rotated upward away from top panel 124 of main body 120 with the user's other hand.

Referring now to FIG. 2, a cut-away view of a first exemplary embodiment of latch release mechanism 170 of the latch assembly is shown. Latch release mechanism 170 comprises release button 172, a resistive member 174 and a plurality of links 176. Resistive member 174 provides sufficient bias to return release button 172 back to a first state after the user has applied a sufficient force to temporarily move release button 172 to a second state. One embodiment for resistive member 174 is a spring.

According to this embodiment of the invention, the plurality of links 176 includes two links 180 and 185, although more links may be utilized. The thickness for each of first and second links 180 and 185 is less than the length of connecting elements 162 and 167 of FIG. 1.

More specifically, first link 180 comprises an inner end 181 rotationally coupled to release button 172 about rotational axis 200. Similarly, an inner end 186 of second link 185 is rotationally coupled to release button 172 about a rotational axis 210. For stability, as an optional feature, mid-section segments 182 and 187 of links 180 and 185 may be pivotally coupled to main body 120 about rotational axes 220 and 230, respectively.

First link 180 further comprises an outer end 183 that comprises a curved (arcuate) edge portion 184 having an appropriate degree of curvature to partially surround connecting element 162 of latch 160 shown in FIG. 1. This prevents unwanted, upward movement of cover 110 when placed in a CLOSED position. As an optional feature, outer end 183 may be a raised segment as shown in greater detail in FIGS. 4A and 4B.

Similarly, an outer end 188 of second link 185 includes a curved edge portion 189 having an appropriate thickness and degree of curvature to surround connecting element 167 of latch 165 shown in FIG. 1.

Based on this configuration, when release button 172 is depressed as identified by arrow 240 and forces exerted against resistive member 174, first and second links 180 and 185 are horizontally rotated toward sidewall 128 of main body 120. According to one embodiment of the invention, the rotation occurs along rotational axes 200 and 210, and optionally along axes 220 and 230.

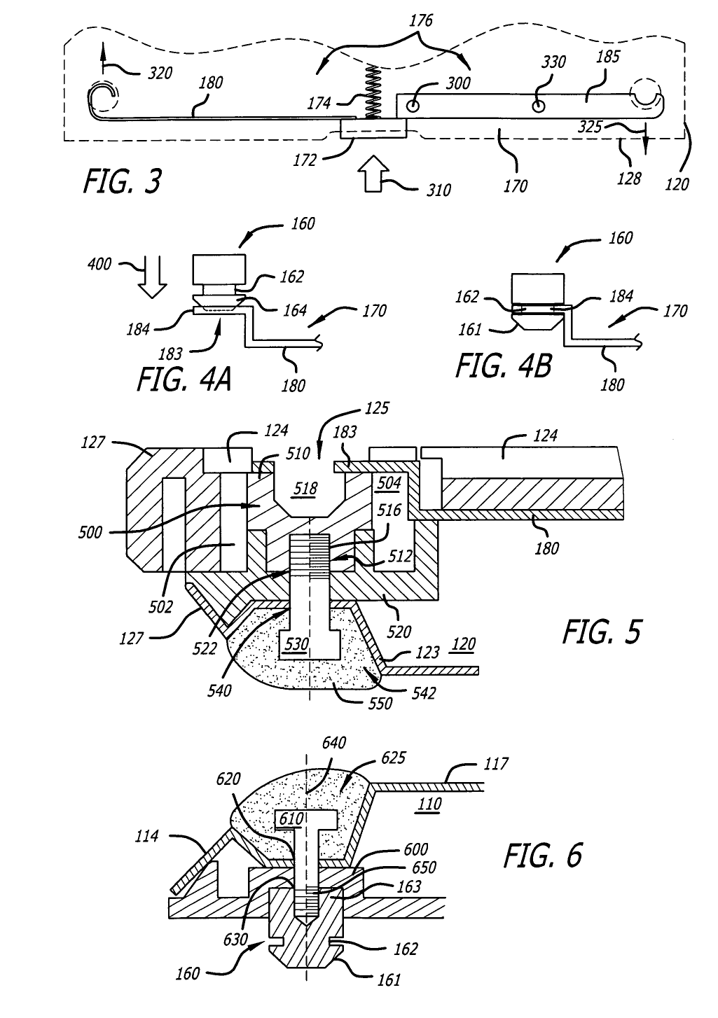

Referring now to FIG. 3, a cut-away view of a second exemplary embodiment of latch release mechanism 170 of FIG. 1 when electronic device 100 is placed in a CLOSED position is shown. Similar to FIG. 2, latch release mechanism 170 comprises release button 172, resistive member 174 and links 176. However, first link 180 is fixedly coupled to release button 172 while second link 185 is pivotally coupled to release button 172 about rotational axis 300.

Hence, when release button 172 is depressed as identified by arrow 310 and forces are exerted against resistive member 174, first link 180 is moved laterally in the direction of arrow 320 while second link 185 is rotated toward sidewall 128 of main body 120 as identified by arrow 325. According to one embodiment of the invention, the rotation occurs along rotational axis 300 and perhaps axis 330.

Referring to FIGS. 4A and 4B, perspective views directed to the operations of latch release mechanism 170 of FIG. 2 when electronic device 100 is placed in a CLOSED position are shown. The operations of first link 180 are consistent with the operations undertaken by second link 185. For clarity sake, only one link (e.g., first link 180) is shown.

As illustrated in FIG. 4A, according to one embodiment of the invention, tapered end portion 161 of latch 160 is moved downward and comes into contact with curved edge portion 184 formed in outer end 183 of first link 180. Further downward movement as indicated by arrow 400 causes horizontal rotation of first link 180 as curved edge portion 184 slides along the surface of tapered end portion 161.

Upon clearing tapered end portion 161, as shown in FIG. 4B, curved edge portion 184 comes into contact with a surface of connecting element 162. At this time, curved edge portion 184 is situated to impede removal of latch 160, and thus, vertical rotation of the cover without activating the release button. Upon activation of the release button, the cover may be vertically rotated after horizontal rotation of first link 180.

Referring now to FIG. 5, a cross sectional view of an exemplary embodiment of one of the latch sockets for the latch assembly is shown. Latch socket 500 comprises a first end 510 adapted to mate with latch 160 of FIG. 1 and a second end 512 adapted for attachment to main body 120. Latch socket 500 is bordered by spacing 502 and 504 separating sidewall 127, first link 180 and top panel 124 from latch socket 500.

In general, latch socket 500 is secured to main body 120 by both a mounting insert 520 and a fastener 530. Mounting insert 520 is partially bordered by sidewall 127 and a bottom panel 123 of main body 120. Mounting insert 520 is sized to receive second end 512 of latch socket 500.

Fastener 530 is inserted through a predefined aperture 540 placed in bottom panel 123 that is aligned with an aperture 522 in mounting insert 520. According to this embodiment of the invention, aperture 540 is made within a recessed area 542 of bottom panel 123 with an overlay material 550 positioned to surround an end of fastener 530. For instance, where fastener 530 is implemented as a screw, overlay material 550 is a screw cap that surrounds a head of the screw.

Once inserted through apertures 522 and 540, fastener 530 is coupled to second end 512 of latch socket 500. One coupling technique may involve second end 512 including a threaded female portion 516 to receive fastener 530, namely a threaded component such as a screw or bolt. When coupled together, fastener 530 is coaxial with latch socket 500 as represented by a dashed line.

According to this embodiment of the invention, first end 510 of latch socket 500 is sized with a recess 518 complementary to tapered end portion 161 of latch 160. First link 180 is positioned so that the curved edge portion of outer end 183 would be adjacent to connecting element 162 when latch 160 is inserted through slot 125 and received by latch socket 500.

Referring to FIG. 6, a cross sectional view of an exemplary embodiment of latch 160 of the latch assembly is shown. Latch 160 comprises tapered end portion 161 adapted to mate with latch socket 500 of FIG. 5 and a second end 163 adapted for attachment to cover 110. Connecting element 162 couples tapered end portion 161 to second end 163.

According to one embodiment of the invention, latch 160 is secured to cover 110 by both a mounting insert 600 and a fastener 610. Mounting insert 600 is partially bordered by edge 114 and a back panel 117 of cover 110. Mounting insert 600 is sized to receive second end 163 of latch 160.

Fastener 610 is inserted through a predefined aperture 620 placed in back panel 117 that is aligned with an aperture 630 in mounting insert 600. According to this embodiment of the invention, aperture 620 is made within a recessed area 625 of back panel 117 with a screw cap 640 positioned to surround a head of a screw used as fastener 610.

Once inserted through apertures 620 and 630, fastener 610 is coupled to second end 163 of latch 160. One coupling technique, as shown, configures second end 163 with a threaded female portion 650 to receive fastener 610 being a threaded component such as a screw or bolt. When coupled together, fastener 610 is coaxial with latch 160 as also represented by a dashed line.

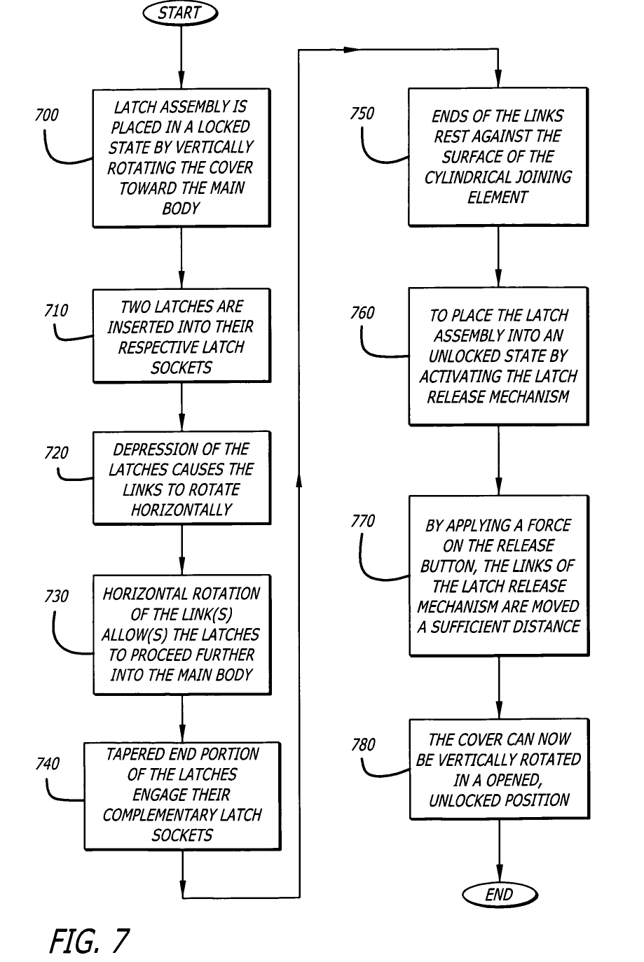

Referring now to FIG. 7, a flowchart of the operations conducted for the dual latch assembly of FIG. 1 is shown. Initially, the latch assembly is placed in a locked state by vertically rotating the cover toward the main body (S700). At least two latches, positioned at opposite corners of a front panel of the cover, are inserted into their respective latch sockets positioned within the main body (S710).

More specifically, the latches contact the actuate ends of links of a latch release mechanism and continued depression of the latches cause the links to rotate horizontally (S720). This horizontal rotation allows the latches to proceed further into the main body until both tapered end portions of the latches engage their complementary latch sockets and the actuate ends of the links rest again the surface of the connecting (e.g., cylindrical joining) elements (S730, S740, S750). Now, the cover is precluded from being vertically rotated upward.

In order to place the latch assembly into an unlocked state by activating the latch release mechanism (S760). For example, activation may be accomplished by the user applying a force to move (e.g., depress, slide, etc.) the release button. By maintaining the applied force on the release button, the links of the latch release mechanism are moved a sufficient distance to provide clearance for the tapered end portions (S770). This allows the cover to be vertically rotated (S780).

While certain exemplary embodiments of the invention have been described and shown in the accompanying drawings, it is to be understood that such embodiments are merely illustrative of and not restrictive on the broad aspects of various embodiments of the invention, and that these embodiments not be limited to the specific constructions and arrangements shown and described, since various other modifications are possible.

What is claimed is:

1. An electronic device, comprising:
a main body including a plurality of latch sockets;
a cover rotationally coupled to the main body and housing a display, the cover including a plurality of latches protruding from a first panel partially forming the cover, the plurality of latches being positioned to engage with the plurality of latch sockets; and
a release mechanism to secure the plurality of latches to their corresponding latch sockets when the cover is placed in a closed position and to concurrently release the plurality of latches when the release mechanism is activated.

2. An electronic device according to claim 1, wherein a first latch of the plurality of latches is placed proximate to a first upper corner of the first panel while a second latch of the plurality of latches is placed proximate to a second upper corner of the first panel.

3. An electronic device according to claim 1, wherein a first latch of the plurality of latches includes a first tapered end and a second end joined together by a connecting element having a diameter less than diameters of the first tapered end and the second end, the first tapered end inserted into a first latch socket of the plurality of latch sockets and secured to the first latch socket by the release mechanism when the cover is placed in the closed position.

4. An electronic device according to claim 3, wherein the first latch is attached to the cover by a fastener coaxial with the first latch.

5. An electronic device according to claim 3, wherein the first latch socket is attached to the main body by a fastener coaxial with the first latch socket.

6. An electronic device according to claim 1, wherein the release mechanism comprises
a release button; and
a plurality of links pivotally coupled to the release button, a first link of the plurality of links being adapted to secure a first latch of the plurality of latches to a first latch socket of the plurality of latch sockets and a second link of the plurality of links being adapted to secure a second latch of the plurality of latches to a second latch socket of the plurality of latch sockets.

7. An electronic device according to claim 6, wherein the release button is spring biased.

8. An electronic device according to claim 3, wherein the release mechanism comprises
a release button; and
a plurality of links pivotally coupled to the release button, a first link of the plurality of links including an edge portion having an appropriate degree of curvature to partially surround the connecting element of the first latch and to secure the first latch to the first latch socket.

9. An electronic device according to claim 1, wherein the release mechanism is situated at a middle portion of a front sidewall of the main body.

10. An electronic device including a main body and a cover rotationally coupled to the main body, comprising:
a latch assembly including
a plurality of latch sockets, and
a plurality of latches configured to engage with the plurality of latch sockets,
where at least a first latch of the plurality of latches is placed on the cover when a first latch socket of the plurality of latch sockets is placed within the main body and alternatively the first latch is placed on the main body when the first socket is placed within the cover; and
a release mechanism operationally cooperating with the latch assembly to secure and subsequently release the plurality of latches from the plurality of latch sockets.

11. An electronic device according to claim 10, wherein the first latch of the latch assembly is placed proximate to a first corner of a front panel of the cover and the first latch socket is placed proximate to a first corner of the main body, the first corner of the front panel being positioned under the first corner of the main body when the cover is rotated and positioned substantially flush against a top panel of the main body.

12. An electronic device according to claim 10, wherein the first latch of the latch assembly includes a first tapered end and a second end joined together by a connecting element having a diameter less than diameters of the first end and the second end, the first tapered end inserted into the first latch socket and secured by the release mechanism when the cover is placed in the closed position.

13. An electronic device according to claim 10, wherein the first latch of the latch assembly is attached to one of the cover and the main body by a fastener coaxial with the first latch.

14. An electronic device according to claim 10, wherein the first latch socket of the latch assembly is attached to one of the cover and the main body by a fastener coaxial with the first latch socket.

15. An electronic device according to claim 10, wherein the release mechanism comprises
a release button; and
a plurality of links coupled to the release button, a first link of the plurality of links being adapted to secure the first latch to the first latch socket and a second link of the plurality of links being adapted to secure a second latch of the plurality of latches to a second latch socket of the plurality of latch sockets.

16. An electronic device according to claim 15, wherein the release button is spring biased.

17. An electronic device according to claim 15, wherein the first link is fixedly coupled to the release button and the second link is rotationally coupled to the release button.

18. An electronic device according to claim 12, wherein the release mechanism comprises
a release button; and
a plurality of links coupled to the release button, a first link of the plurality of links including an edge portion having an appropriate degree of curvature to partially surround the connecting element of the first latch and to secure the first latch to the first latch socket.

19. A latch assembly adapted to an electronic device, comprising:
a plurality of latch sockets;
a plurality of latches configured to engage with the plurality of latch sockets, each of the plurality of latches includes a tapered end protruding from a surface of a component of the electronic device; and
a release mechanism adapted for securing and subsequently releasing the plurality of latch sockets from the plurality of latch sockets, the release mechanism including
a spring-biased release button, and
a plurality of links rotationally coupled to the release button, a first link of the plurality of links to prevent vertical movement of a first latch of the plurality of latches when the first link is placed in a first position until the release button is depressed to cause rotation of the first link for placement into a second position.

20. A latch assembly according to claim 19, wherein the plurality of latches are positioned at corners of the component being a cover housing a display for the electronic device.
